(19) United States
(12) Patent Application Publication
(10) Pub. No.: US 2012/0171587 A1
(43) Pub. Date: Jul. 5, 2012

(54) Conducting ceramics for electrochemical systems

(75) Inventors: Jack A. Shindle, Rutland, MA (US); Scott C. Rackey, Bedford, MA (US); Gonghou Wang, Westborough, MA (US); Reinder J. Boersma, Webster, MA (US)

(73) Assignee: CTP Hydrogen Corporation, Westborough, MA (US)

(21) Appl. No.: 11/729,955

(22) Filed: Mar. 29, 2007

Related U.S. Application Data
(63) Continuation-in-part of application No. PCT/US05/35714, filed on Oct. 5, 2005.
(60) Provisional application No. 60/787,555, filed on Mar. 30, 2006.
(60) Provisional application No. 60/899,865, filed on Feb. 6, 2007.
(60) Provisional application No. 60/616,475, filed on Oct. 5, 2004.
(60) Provisional application No. 60/662,321, filed on Mar. 16, 2005.

(51) Int. Cl. H01M 8/18; C25B 9/10; B32B 18/00; C25B 1/10; H01M 8/06; B32B 5/18

(52) U.S. Cl. 429/418; 429/417; 429/422; 428/304.4; 428/319.1; 428/34.1; 428/316.6; 205/637; 204/263; 205/629; 205/634; 205/334; 204/252

(57) ABSTRACT

The present invention generally relates to conducting materials such as mixed ionically and electrically conducting materials. A variety of materials, material compositions, materials with advantageous ratios of ionically and electrically conducting components, structures including such materials, and the like are provided in accordance with the invention. In one aspect, the invention relates to conducting ceramics for electrochemical systems and, in particular, to mixed ionically and electrically conducting ceramics which can be used, for example, for electrochemical systems and, in particular, to mixed ionically and electrically conducting ceramics which can be used, for example, for hydrogen gas generation from a gasified hydrocarbon stream. One aspect of the invention provides a material comprising a first phase comprising a ceramic ionic conductor, and a second phase comprising a ceramic electrical conductor. An example of such a material is a material comprising ZrO₂ doped with Sc₂O₃ and SrTiO₃ doped with Y₂O₃. Another aspect of the invention provides systems and methods of hydrogen gas generation from a fuel, such as a carbonaceous fuel, using materials such as those described above, for example, present within a membrane in a reactor. In some embodiments, a substantially pure hydrogen stream may be generated through in situ electrolysis. In some cases, a material such as those described above may be used to facilitate ion and/or electron exchange between a first reaction involving a fuel such as a carbonaceous fuel, and a second reaction involving a water-hydrogen conversion reaction (i.e., where water is reduced to produce hydrogen gas). In other aspects, the invention provides systems and methods for producing power from a fuel source, such as a carbonaceous fuel source.

### RELATED APPLICATIONS

This application claims priority to all of the following according to the following recitation of priority relationships. This application claims the benefit of U.S. Provisional Patent Application Ser. No. 60/787,555, filed Mar. 30, 2006, entitled “Conducting Ceramics for Electrochemical Systems,” by Rackey, et al. and U.S. Provisional Patent Application Ser. No. 60/899,865, filed Feb. 6, 2007, entitled “Architectures for Electrochemical Systems,” by Rackey, et al. This application is also a continuation-in-part of International Patent Application No. PCT/US2005/035714, filed Oct. 5, 2005, entitled “Conducting Ceramics for Electrochemical Systems,” by Rackey, et al., published as WO 2006/041854 on Apr. 20, 2006, which claims priority to U.S. Provisional Patent Application Ser. No. 60/616,475, filed Oct. 5, 2004, entitled “Conducting Ceramics for Hydrogen Generation,” by Rackey, et al. and U.S. Provisional Patent Application Ser. No. 60/662,321, filed Mar. 16, 2005, entitled “Conducting Ceramics for Electrochemical Systems,” by Rackey, et al. Each of these is incorporated herein by reference.

### FIELD OF INVENTION

The present invention generally relates to conducting ceramics for electrochemical systems and, in particular, to mixed ionically and electrically conducting ceramics.

### BACKGROUND

Currently, there is great interest in using hydrogen as a fuel source. Hydrogen can be produced, for example, from carbonaceous fuels. Conventional methods for the separation of hydrogen from carbonaceous fuels typically require the steps as shown in FIG. 1. In summary, these include: (1) a gasification reaction of a carbonaceous fuel to produce a syngas (a mixture of water (H₂O), carbon monoxide (CO) and other compounds); (2) a clean-up step, where particulates are removed from the syngas stream; (3) a water-gas shift reaction, where the water and carbon monoxide are reacted to produce hydrogen gas (H₂) and carbon dioxide (CO₂); and (4) separation of the hydrogen gas.

Syngas can be obtained by reacting a carbonaceous fuel with steam, air, or pure oxygen to create a mixture of hydrogen, carbon monoxide, carbon dioxide, water, and lower hydrocarbons. Particulates and contaminants produced by this reaction are removed in subsequent steps. The syngas stream is then reacted to form hydrogen gas through the water-gas shift reaction by passing the syngas stream over a suitable catalyst. The water-gas shift reaction is as follows:

H₂O+CO⇄H₂+CO₂.

More advanced “shift” reactors attempt to attain chemical equilibria at a reduced temperature, while also performing the entire water-gas shift reaction in a single reactor. A subsequent separation step is thus required to remove the CO₂ that is produced in this reaction, which in this process, is typically done by pressure swing adsorption techniques. However, pressure swing adsorption techniques can be energy intensive and cannot be performed in a continuous manner.

Other examples of methods of gas separation include diffusion methods that use a difference in diffusion coefficients between gas molecules passing through a material to effect gas separation. The materials used in these methods typically have either a microporosity that allows smaller molecules to diffuse at a higher rate than larger molecules, and/or preferentially dissolves certain atoms or molecules, which creates a difference in their ability to be transported through the material. However, fouling of these materials, as well as cost and energy intensity, are among the reasons that more advanced hydrogen gas separation methods are still needed.

### SUMMARY OF THE INVENTION

In one aspect, the present invention generally relates to mixed ionically and electrically conducting materials in a variety of arrangements for a variety of uses. In one set of embodiments, the invention relates to conducting ceramics for electrochemical systems and, in particular, to mixed ionically and electrically conducting ceramics. Various embodiments of the invention involve relatively non-porous, or dense, mixed conducting materials, mixed conducting materials with relatively low combined resistivity, specific materials for use as mixed ionically and electrically conducting materials with particular phase particle or grain size or scale, and structures including mixed ionically and electrically conductive materials in multi-layer arrangements including porous and non-porous structures, some structures of which can support others in the arrangement.

The invention also relates, in another aspect, to systems for generating energy from a fuel in which a reactor allows fuel (and related impurities, if present) to be physically separated from a fuel cell or a related electrochemical energy conversion device that could be harmed or fouled by the impurities or other components of the fuel. In some cases, however, the reactor and the fuel cell may be in thermal communication, for example, as discussed in a U.S. patent application, entitled “Architectures for Electrochemical Systems” by Rackey, et al., filed on even date herewith, incorporated herein by reference. The invention also relates, in certain embodiments, to electrochemical energy conversion systems able to react hydrogen to produce electrical energy and water, generating hydrogen from the water, and using the hydrogen as fuel in an electrochemical reaction to generate energy.

In yet another aspect, a system is provided which combines several of the individual invention aspects described herein. In this system, a fuel, including or based solely on hydrogen, is reacted in a first portion of the reactor (e.g., a fuel cell or other electrochemical device) to produce electrical energy. Exhaust, including water, is produced in the reaction, which is re-converted to hydrogen in a second portion of the reactor in an electrochemical reaction driven by consumption of a second, different fuel. The first portion and second portion may be contained within the same chamber or vessel, or the first and second portions may be in separate vessels that are in fluidic communication, e.g., using pipes, tubing, or the like.

The hydrogen thus generated can be used to generate electricity in the first portion, again producing water, which can be reconverted to hydrogen in the second portion in a cyclical manner, in some embodiments of the invention. In other embodiments, the hydrogen produced in the second portion from water produced by the first portion can also be used for other purposes, for example, as fuel for an electrochemical device not involving either the first or second portions.

In some embodiments, the second portion involves a mixed ionically and electrically conducting material which physically isolates the water produced in the first portion from a second fuel provided in the second portion, except for ionic and/or electronic conduction across the mixed conducting material. In this way, the second fuel, including any impurities if present, can be physically isolated from the first portion, thereby preventing contamination of the first portion if such contamination could be detrimental to the first portion.

The subject matter of the present invention involves, in some cases, interrelated products, alternative solutions to a particular problem, and/or a plurality of different uses of one or more systems and/or articles.

In one aspect, the invention is a method. In one set of embodiments, the method includes acts of reacting a fuel comprising hydrogen to generate electricity and water in a first portion of a reactor, reacting the water to generate hydrogen in a second portion of the reactor, and reacting at least a portion of the hydrogen generated in the second portion of the reactor to produce electricity. The method, according to another set of embodiments, includes acts of reacting a fuel and water across a mixed ionically and electrically conducting material, wherein the water is isolated from the fuel except for ionic and electronic conduction across the material, to generate hydrogen, and reacting at least a portion of the hydrogen to produce electricity. In yet another set of embodiments, the method inclduse acts of reacting a fuel comprising hydrogen to generate electricity and water in a first portion of a reactor, reacting the water to generate hydrogen in a second portion of the reactor, and reacting at least a portion of the hydrogen generated in the second portion of the reactor to produce electricity.

The method, in one set of embodiments, includes an act of reacting water to produce H₂ having a purity of at least about 90% (not inclusive of any residual, unreacted water that may be present) using electrons provided by a material comprising a first phase comprising a ceramic ionic conductor and a second phase comprising a ceramic electrical conductor. In another set of embodiments, the method includes acts of reacting a carbonaceous fuel to produce electrons within a material, and reacting the electrons with water to produce oxygen ions within the material, the oxygen ions being able to react with the carbonaceous fuel. In yet another set of embodiments, the method includes acts of reacting an oxidizable species to produce electrons within a material, and reacting the electrons with a reducible species that is not in physical contact with the oxidizable species to produce H₂. In some of these embodiments, the first phase is substantially interconnected throughout the material such that the material is ionically conductive, and the second phase is substantially interconnected throughout the material such that the material is electronically conductive.

In one set of embodiments, the method includes acts of providing a mixed ionically and electrically conducting material having a first side and a second side, flowing an oxidizable species across the first side of the material, and flowing a reducible species across the second side of the material in a direction that is substantially countercurrent relative to the flow of the oxidizable species.

The invention includes a reactor in another aspect. In one set of embodiments, the reactor includes a material separating a chamber into a first compartment and a second compartment, a carbonaceous fuel source in fluidic communication with an inlet of the first compartment, and a source of water in fluidic communication with an inlet of the second compartment. In certain embodiments, the material comprises a first phase comprising a ceramic ionic conductor and a second phase comprising a ceramic electrical conductor. In some cases, the first phase is substantially interconnected throughout the material such that the material is ionically conductive, and the second phase is substantially interconnected throughout the material such that the material is electronically conductive.

In another set of embodiments, the reactor comprises a mixed ionically and electrically conducting material having a first side and a second side, a source of an oxidizable species directed for flow across the first side of the material, and a source of a reducible species directed for flow across the second side of the material in a direction that is substantially countercurrent relative to the flow of the oxidizable species. The reactor, in yet another set of embodiments, includes a mixed ionically and electrically conducting material, having a porosity of less than about 1 open pore/mm², separating a chamber into a first compartment and a second compartment.

In still another set of embodiments, the reactor includes a material separating a chamber into a first compartment and a second compartment, where the material comprises a first phase comprising a ceramic ionic conductor and a second phase comprising a ceramic electrical conductor. In some cases, the first phase is substantially interconnected throughout the material such that the material is ionically conductive, and the second phase is substantially interconnected throughout the material such that the material is electronically conductive. In certain embodiments, the ceramic electrical conductor includes a ceramic having a formula A_{1-y}SrₓTiO₃, where x is between about 0.1 and about 0.99, y may be between x and 2x, for instance, about 1.5x, and A represents one or more atoms, each independently selected from the group consisting of Sc, Ce, Y, La, Nb, Yb, Gd, Sm, and Pr. In other embodiments, the ceramic electrical conductor includes a ceramic having a formula A_{1-y}EₓTiO₃, where x is between about 0.1 and about 0.99, y may be between x and 2x, for instance, about 1.5x, A represents one or more atoms, each independently selected from the group consisting of Y, La, Nb, Yb, Gd, Sm, Sc, Ce and Pr, and E represents one or more atoms, each independently selected from the Group 2 elements, for example, one or more of Be, Mg, Ca, Sr, and/or Ba. As specific, non-limiting examples, the ceramic may have a formula A_{1-y}MgₓTiO₃, A_{1-y}CaₓTiO₃, A_{1-y}SrₓTiO₃, A_{1-y}BaₓTiO₃, etc.

The reactor, in another set of embodiments, comprises a mixed ionically and electrically conducting material separating a chamber into a first compartment and a second compartment. In some embodiments, the material comprises a first phase comprising a YSZ (“yttria-stabilized zirconia”) material and a second phase comprising a YST (“yttrium doped SrTiO₃”) material. In other embodiments, the second phase may comprise a yttrium doped Group 2 titanium oxide material, for example, yttrium doped MgTiO₃, yttrium doped CaTiO₃, yttrium doped BaTiO₃, yttrium doped SrTiO₃, etc., as well as combinations thereof. In some cases, the first phase is substantially interconnected throughout the material such that the material is ionically conductive, and the second phase is substantially interconnected throughout the material such that the material is electronically conductive. In still another set of embodiments, the reactor comprises a material separating a chamber into a first compartment and a second compartment, where the material has a resistivity of less than about 1000 Ohm cm at the operating temperature of between about 500° C. and about 1200° C. In some embodiments, the material comprises a first phase comprising a ceramic ionic conductor and a second phase comprising a ceramic electrical conductor. In still another set of embodiments, the reactor comprises a material separating a chamber into a first compartment and a second compartment.

Another aspect of the invention is directed to a system. The system includes, in one set of embodiments, a gasification chamber; a source of fuel in fluidic communication with the gasification chamber; a separation chamber, contained within the gasification chamber, fluidically separated from the gasification chamber, at least in part, by a material comprising a ceramic, wherein the material is ionically conductive; and a source of water in fluidic communication with the second compartment.

Yet another aspect of the invention is directed to an article. The article comprises, in one set of embodiments, a substantially non-porous material comprising a first phase comprising a ceramic ionic conductor and a second phase comprising a ceramic electrical conductor, and a porous substrate in physical contact with the material. In some cases, the first phase is substantially interconnected throughout the material such that the material is ionically conductive, and the second phase is substantially interconnected throughout the material such that the material is electronically conductive. In another set of embodiments, the article includes a first, porous mixed ionically and electrically conducting material, and a non-porous mixed ionically and electrically conducting material in physical contact with the first, porous mixed conduction material.

In another aspect, the present invention is directed to a method of making one or more of the embodiments described herein, for example, a material comprising a first phase comprising a ceramic ionic conductor, and a second phase comprising a ceramic electrical conductor. In yet another aspect, the present invention is directed to a method of using one or more of the embodiments described herein, for example, a material comprising a first phase comprising a ceramic ionic conductor, and a second phase comprising a ceramic electrical conductor.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is schematic representation of a process to produce hydrogen gas from a carbonaceous fuel source;

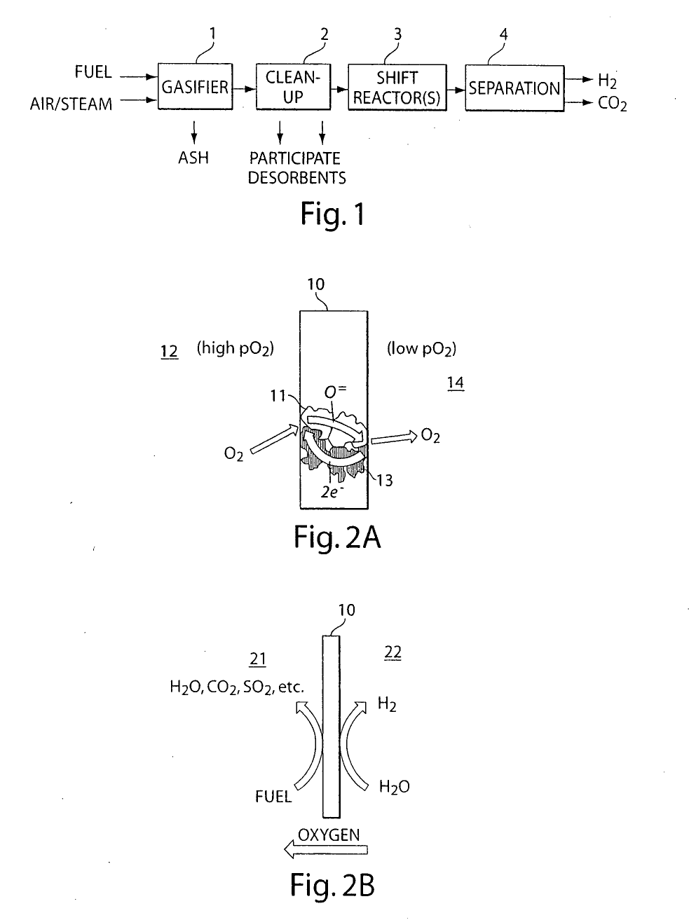

FIGS. 2A and 2B are schematic representations of various embodiments of the invention, in which a material of the invention is used in an electrochemical device;

FIG. 3 is an XRD pattern of a YST-8YSZ material that was prepared in accordance with one embodiment of the invention, as compared to XRD patterns of isolated YST and isolated 8YSZ;

FIG. 4 is a schematic representation of an embodiment of the invention, as used in a reactor to oxidize a fuel such as coal to produce hydrogen gas;

FIG. 5 is a schematic representation of another embodiment of the invention, as used in a reactor to oxidize a fuel such as coal to produce hydrogen gas; and

FIGS. 6A-6D are schematic diagrams of various fuel cells that can be used with various embodiments of the invention, and the chemical reactions that may occur during use.

### DETAILED DESCRIPTION

The present invention generally relates, in some aspects, to conducting materials such as mixed ionically and electrically conducting materials. A variety of materials, material compositions, materials with advantageous ratios of ionically and electrically conducting components, structures including such materials, and the like are provided in accordance with the invention.

In one set of embodiments, the invention relates generally to conducting ceramics for electrochemical systems and, in particular, to mixed ionically and electrically conducting ceramics which can be used, for example, for hydrogen gas generation from a gasified hydrocarbon stream. While mixed ceramic conductors are known in the art, the present invention provides, in various embodiments, multi-phase systems of select materials combined in specific ways to achieve advantageous conductive properties, thin conductive materials optionally supported in multi-layer arrangements, and the like.

One aspect of the invention provides a material comprising a first phase comprising a ceramic ionic conductor, and a second phase comprising a ceramic electrical conductor. Non-limiting examples of such a material include materials comprising ZrO₂ doped with CeO₂, Sc₂O₃, and/or yttrium-doped SrTiO₃ or another yttrium doped Group 2 titanium oxide material, for example, yttrium doped MgTiO₃, yttrium doped CaTiO₃, yttrium doped BaTiO₃, yttrium doped SrTiO₃, etc., as well as combinations thereof. Another aspect of the invention provides systems and methods of hydrogen gas and/or power generation from a fuel, such as a carbonaceous fuel, using materials such as those described above, for example, present within a membrane in a reactor. In some embodiments, a substantially pure hydrogen stream may be generated through in situ electrolysis. In some cases, a material such as those described above may be used to facilitate ion and/or electron exchange between a first reaction involving a fuel such as a carbonaceous fuel, and a second reaction involving a water-hydrogen conversion reaction (i.e., where water is reduced to produce hydrogen gas). In other aspects, the invention provides systems and methods for producing power from a fuel source, such as a carbonaceous fuel source.

Various embodiments of the invention use fuels such as carbonaceous fuels for consumption and/or driving various chemical reactions such as the production of hydrogen. Examples of carbonaceous fuels include, but are not limited to, conductive carbon, graphite, quasi-graphite, coal, coke, charcoal, fullerene, buckminsterfullerene, carbon black, activated carbon, decolorizing carbon, hydrocarbon fuels, an oxygen-containing hydrocarbon, carbon monoxide, fats, oils, a wood product, a biomass and combinations thereof. Hydrocarbon fuels can be arbitrarily represented using the formula CₓH_{y}, although in reality, hydrocarbon fuels may also contain additional impurities besides carbon and hydrogen, for example, sulfur (S), oxygen (O), nitrogen (N), or the like. It should therefore be understood that, as used herein, references to “hydrocarbon fuels” or “CₓH_{y},” or similar terms, may also include other impurities besides hydrocarbons, such as sulfur, oxygen, nitrogen, etc. Thus, non-limiting examples of hydrocarbon fuels will include saturated and unsaturated hydrocarbons, aliphatics, alicyclics, aromatics, and mixtures thereof. Other non-limiting examples of hydrocarbon fuels include gasoline, diesel, kerosene, methane, propane, butane, natural gas, and mixtures thereof. Examples of oxygen-containing hydrocarbon fuels include alcohols which further include C₁-C₂₀ alcohols and combinations thereof. Specific examples include methanol, ethanol, propanol, butanol and mixtures thereof.

One embodiment of the invention uses, as a fuel, coal, such as bituminous coal. Natural coal contains significant amounts of bound hydrogen and water. For instance, in bituminous Kentucky coal, the atomic composition is approximately CH_{0.81}O_{0.08}, which upon gasification yields a gas mixture with a partial oxygen pressure of about 10⁻²⁰ bar at 800° C. Additional examples of suitable fuels include, but are not limited to, fluidized fuels such as gasified coal, gasified petroleum coke, gasified oils, gasified waxes, gasified plastics, gasified waste streams, gasified biologically derived fuels such as wood, agricultural waste, sewage sludge, or landfill gas, sewage treatment plant digester gas, natural gas, methane, propane, butane, diesel, gasoline, crude oil, bunker (a by-product from the petrochemical industry), etc.

As mentioned above, one aspect of the invention is directed to a material that is able to conduct both ions and electrons, i.e., the material exhibits “mixed conduction,” since the material is both ionically and electronically conducting. This material may be referred to herein as a “mixed ionically and electrically conducting material,” a “mixed conduction material,” or a “MIEC” material. For example, the material may include a unitary material that is both ionically and electronically conducting, or the material may comprise two or more discrete phases (i.e., discrete regions within the material that have substantially the same composition). Non-limiting examples of such materials are disclosed in International Patent Application No. PCT/US2005/035714, filed Oct. 5, 2005, entitled “Conducting Ceramics for Electrochemical Systems,” by S. Rackey, et al., published as WO 2006/041854 on Apr. 20, 2006; and U.S. Provisional Patent Application Ser. No. 60/787,555, filed Mar. 30, 2006, entitled “Conducting Ceramics for Electrochemical Systems,” by S. Rackey, et al., each incorporated herein by reference.

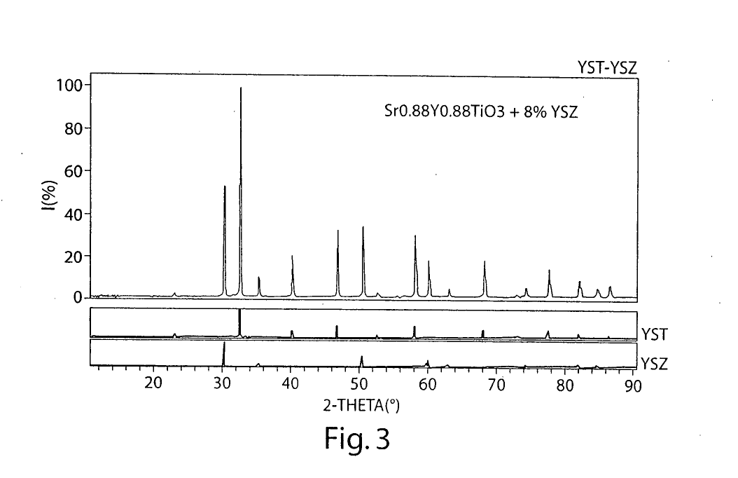

For example, as is shown in FIG. 2A, a material of the invention 10 may be used in a reactor, separating a high oxygen partial pressure environment 12 from a low oxygen partial pressure environment 14. Material 10, in this example, includes ionically conducting phase 11, which is able to conduct oxygen ions, and an electrically conducting phase 13, which is able to transport electrons. In such a reactor, using suitable reactants, the net result may be oxygen transport across the material from region 12, having a high oxygen partial pressure to region 14, having a low oxygen partial pressure. For example, in compartment 12, a reduction process may occur (e.g., the conversion of water to hydrogen gas), while in compartment 14, an oxidation process may occur (for example, the conversion of a fuel to an oxidized fuel, which may be partial or complete oxidation, e.g., to water, carbon dioxide, SO₂, etc.). Due to the ionization of the oxygen, an electrical field may also be created across the material in some embodiments, which may form at least a portion of the driving force for transport across the ceramic. It should be noted that although oxygen is used in this example, as the ion transported across material 10, in other embodiments, other species may be transportable across material 10 instead, or in addition to oxygen, for example, hydrogen.

Different phases in a mixed conduction material can be identified, for example, by identification of the individual portions of material defining the ionically or electrically conductive portions. For example, where the mixed conduction material is ceramic, as described in more detail below, different phases can be identified by identification of individual ceramic grains within the material, in which each phase of the material generally comprises grains having different chemical compositions and/or lattice structures. Discrete phases within a material can be readily identified by those of ordinary skill in the art, for example, using known techniques such as electron microscopy or the like.

In some cases, the materials of the invention, or at least a portion of the material (for example, one or more discrete phases of the material), comprises a ceramic. For instance, in certain embodiments, the material comprises at least two phases, including a first phase comprising a ionic conductor, and a second phase comprising a electrical conductor, where the first phase and/or the second phase is a ceramic. Non-limiting examples of such materials include YST-YSZ compounds; YST-ScSZ compounds; YST-CGO compounds; a yttrium doped Group 2 titanium oxide material and a YSZ, ScSZ and/or CGO compound; or the like, as described in more detail below.

If two or more phases are present, in certain embodiments, they are arranged with respect to each other such that the first phase is substantially interconnected throughout the bulk of the material such that the material is ionically conductive, and/or the second phase is substantially interconnected throughout the material such that the material is electronically conductive. As used herein, “substantially interconnected” refers to a pathway that extends from a first surface of the material to a second surface that stays within only one phase of the material. Thus, for instance, an ionically conductive pathway would allow an ion, such as oxygen, to be transported from a first surface of the material to a second surface of the material while remaining in only one phase of the material, while an electronically conductive pathway would allow electrons to be transported within only one phase of the material from a first surface of the material to a second surface of the material. Preferably, multiple interconnected pathways exist in the material such that there are multiple ionically conductive pathways and multiple electrically conductive pathways from the first surface to the second surface of the material sufficient to achieve, in some embodiments, conductive and/or resistive properties as described below. Those of ordinary skill in the art can readily formulate materials using the disclosure herein to achieve these results. As examples, the material may, comprise a first ionically conductive phase and a second electronically conductive phase that intertwines (e.g., 3-dimensionally) with the first phase, or the material may comprise a third phase, through which a first ionically conductive phase and a second electronically conductive phase pass.

If two phases are present in the material, the phases may be present in any ratio, for example, the ionically conductive phase may be present in the material at a percentage of between about 5% and 98% by weight, between about 10% and about 95% by weight, between about 30% and about 92% by weight, between about 40% and about 90% by weight, etc., with the balance being the electrically conductive phase. In some embodiments, for example in the case of ceramic mixed ionically and electrically conducting materials, one phase (e.g., the ionically conductive phase in the case of most ceramic materials) is significantly more resistive than the electrically conductive phase. The present invention recognizes this characteristic and, accordingly, provides the ability to tailor the ratios of the two materials relative to each other (as well as other properties such as density) to impart balanced conductivity while maintaining good conductivity of each phase throughout the material. That is, in such a situation more ionically conductive material can be provided relative to the electrically conductive material, to offset the increased resistivity of the ionically conductive phase, without altering the ratio of ionically to electrically conductive material so much so that the electrically conductive material is not present in sufficient quantity to provide sufficient electrically conductive interconnected pathways throughout the material to provide sufficient electric conductivity. For example, the ionically conductive phase may be present in a percentage as described above, or between about 50% to about 90% by weight, or 60% to about 88% by weight, with the balance being the electrically conductive phase. In other embodiments, these ratios exist between the ionically and electrically conductive phases relative to each other, but other components in the material can be present, reducing the overall amount of both the electrically and ionically conductive materials below their percentage presence relative to each other.

As used herein, an “ionically conducting material” is a material in which one or more types of ions are able to be transported through, for example, oxygen ions or hydrogen ions. In one set of embodiments, the ionic conductor is, or comprises, a ceramic ionic conductor. The ceramic ionic conductor may comprise, in some cases, one or more of a La-ferrite material, a ceria, and a zirconia, each of which may be doped or undoped, as described in more detail below. A non-limiting example of a ceramic ionic conductor is La-ferrite material, e.g., a material comprising La, Sr, Cr, Fe, and O (for example, an “LSCrF” material such as La_{0.2}Sr_{0.8}Cr_{0.8}O₃). Other non-limiting examples of ceramic ionic conductors include materials comprising La, Cr, Fe, O, and a Group 2 element, such as Be, Mg, Ca, Sr, and/or Ba, for example, La_{0.2}Mg_{0.8}Cr_{0.2}Fe_{0.8}O₃, La_{0.2}Ca_{0.8}Cr_{0.2}Fe_{0.8}O₃, La_{0.2}Sr_{0.8}Cr_{0.2}Fe_{0.8}O₃, La_{0.2}Ba_{0.8}Cr_{0.2}Fe_{0.8}O₃, etc.

In some cases, the ceramic ionic conductor has a perovskite structure, a cubic structure, or a fluorite structure. At relatively low oxygen partial pressures (for example, at a pO₂ below about 10⁻¹⁵ bar), the ceramic ionic conductor may have an ionic conductivity of about 0.02 S/cm or 0.2 S/cm to about 0.8 S/cm at a temperature of between about 800° C. and about 1000° C. In other cases, the ionic conductivity may be at least about 0.2 S/cm, at least about 0.3 S/cm, at least about 0.4 S/cm, at least about 0.5 S/cm, at least about 0.6 S/cm, at least about 0.7 S/cm, at least about 0.8 S/cm, at least about 0.9 S/cm, or at least about 1.0 S/cm or more at such temperatures.

In one embodiment, the ionic conductor comprises a cerate (i.e., a cerium oxide), for example, ceria or CeO₂. Examples of ceria-containing materials include, but are not limited to, a CeO₂-based perovskite, such as Ce_{0.9}Gd_{0.1}O₂ or Ce₁₋ₓGdₓO₂, where x is no more than about 0.5, or lanthanum-doped ceria, such as (CeO)₁₋ₙ(LaO₅)ₙ where n is from about 0.01 to about 0.2. In some cases, the ceria may be doped with gadolinium. For example, during production, a gadolinium oxide and a cerium oxide may be mixed together to produce a “CGO” (gadolinium-doped cerium oxide). The CGO material may have a perovskite structure. The CGO material may include about 10% to about 20% or 30% gadolinium, about 12% to about 18% gadolinium, or about 18% to about 22% gadolinium. In certain cases the CGO material may have a conductivity of between about 0.06 S/cm and about 0.24 S/cm at a temperature of between about 700° C. and about 900° C., at relatively low oxygen partial pressures (e.g., below about 10⁻¹⁵ bar), and/or in an oxidizing atmosphere. Below a partial pressure of about 10⁻¹⁵ bar, the CGO material may exhibit higher ionic conductivities. For instance at a partial pressure of 10⁻¹⁸ bar and a temperature of 900° C., the CGO material may have an ionic conductivity of over about 0.4 S/cm and an electronic conductivity of about 1.6 S/cm. CGO may also have the added benefit of acting as a catalyst for reduction. Such a reduction may effectively increase the interfacial area of the material.

In yet another embodiment of the invention, the ionic conductor comprises a zirconia (i.e., a zirconium oxide material). Examples of zirconia materials include, but are not limited to, (ZrO2)(ZrO₂)(HfO₂)_{0.02}(Y₂O₃)_{0.08}, (ZrO₂)(Y₂O₃)_{0.08}, (ZrO₂)(HfO₂)_{0.02}(Y₂O₃)_{0.08}, (ZrO₂)(HfO₂)_{0.02}(Y₂O₃)_{0.05}, (ZrO₂)(HfO₂)_{0.02}(Y₂O₃)_{0.08}(TiO₂)_{0.10}, (ZrO₂)(HfO₂)_{0.02}(Y₂O₃)_{0.08}(Al₂O₃)_{0.10}, (ZrO₂)(Y₂O₃)_{0.08}(Fe₂O₃)_{0.05}, (ZrO₂)(Y₂O₃)_{0.08}(CoO)_{0.05}, (ZrO₂)(Y₂O₃)_{0.08}(ZnO)_{0.05}, (ZrO₂)(Y₂O₃)_{0.08}(NiO)_{0.05}, (ZrO₂)(Y₂O₃)_{0.08}(CuO)_{0.05}, (ZrO₂)(Y₂O₃)_{0.08}(MnO)_{0.05} and ZrO₂CaO. In some embodiments, the zirconia may be stabilized in a cubic structure using one or more dopants, for example, metals such as nickel, or transition metals such as Y or Sc, which can be added in a quantity sufficient to give the doped zirconia a cubic structure. For instance, during production of the zirconia, yttria (Y₂O₃) and/or scandia (Sc₂O₃) may be added as a dopant material to produce a yttria-stabilized zirconia material (“YSZ”), a scandia-stabilized zirconia material (“ScSZ”), or a zirconia stabilized with both yttria and scandia. As used herein, a material that “stabilizes” zirconia is a material that has been added (doped) to the zirconia in a quantity sufficient to cause the zirconia to form a cubic structure. The yttria and/or scandia may be added in any suitable concentration, for example, at mole ratios of about 2 mol %, about 4 mol %, about 6 mol %, about 8 mol %, about 10 mol %, between about 5 mol % or about 6 mol % to about 10 mol %, between about 5 mol % or about 6 mol % to about 15 mol %, etc. As non-limiting examples, an “8YSZ” material (i.e., a YSZ material doped with 8 mol % yttria) can be prepared, which may have an ionic conductivity of between about 0.02 S/cm to about 0.1 S/cm at a temperature of between about 800° C. and about 1000° C.; or a “10ScSZ” material (i.e., a ScSZ doped with 10 mol % scandia) can be prepared, which may have an ionic conductivity of between about 0.1 S/cm and about 0.3 S/cm at a temperature of between about 800° C. and about 1000° C. YSZ that is not compounded with an ionically-conductive material may also be useful in certain embodiments.

In still other embodiments, the ionic conductor may comprise a material having a formula (ZrO₂)(HfO₂)ₐ(TiO₂)_{b}(Al₂O₃)_{c}(Y₂O₃)_{d}(MₓO_{y})ₑ where a is from 0 to about 0.2, b is from 0 to about 0.5 c is from 0 to about 0.5, d is from 0 to about 0.5, x is greater than 0 and less than or equal to 2, y is greater than 0 and less than or equal to 3, e is from 0 to about 0.5, and M is selected from the group consisting of calcium, magnesium, manganese, iron, cobalt, nickel, copper, and zinc. Non-limiting examples include a LaGaO₃-based perovskite oxide, such as La₁₋ₓAₓGa_{1-y}B_{y}O₃ where A can be Sr or Ca, B can be Mg, Fe, Co and x is from about 0.1 to about 0.5 and y is from about 0.1 to about 0.5 (e.g. La_{0.9}Sr0_{0.1}Ga_{0.8}Mg_{0.2}O₃); a PrGaO₃-based perovskite oxide electrolyte, such as Pr_{0.93}Sr_{0.07}Ga_{0.85}Mg_{0.15}O₃ or Pr_{0.93}Ca_{0.07}Ga_{0.85}Mg_{0.15}O₃; and a Ba₂In₂O₅-based perovskite oxide electrolyte, such as Ba₂(In₁₋ₓGaₓ)₂O₅ or (Ba₁₋ₓLaₓ)In₂O₅, where is x is from about 0.2 to about 0.5.

As used herein, an “electronic conducting material” is a material through which electrons can be readily transported. The electronic conductor may be, for example, a conducting material or a semiconducting material. The electronic conductor, in one set of embodiments, may be, or comprise, a ceramic electronic conductor. For instance, the ceramic electronic conductor may comprise one or more of a LST material, a YST material, a YLST material, a yttrium doped Group 2 titanium oxide material, and/or an LCC material. As used herein, “LCC” refers to any lanthanum-calcium-chromium oxide, i.e., the LCC material comprises La, Ca, Cr, and O, for example, La_{0.8}Ca_{0.2}CrO₃. La_{0.8}Ca_{0.2}CrO₃ can have, in some embodiments, an electronic conductivity of ranging between about 40 S/cm (e.g., in reducing atmospheres) to about 80 S/cm (e.g., in oxidizing atmospheres). In some cases, pressureless sintering to full density of the LCC at 1400° C. may be used.

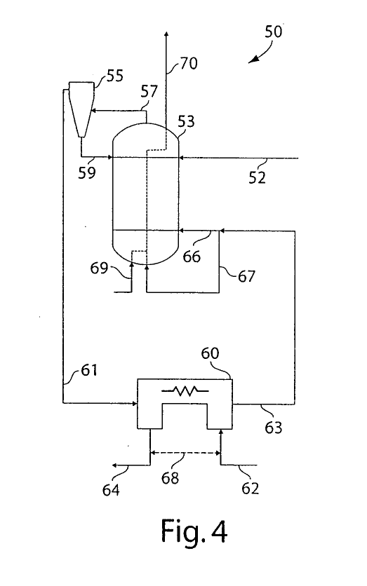

In one embodiment, the ceramic electronic conductor comprises a doped strontium titanate material or a YST (Y—Sr—Ti) material, i.e., a ceramic material comprising Y, Sr, Ti, and O, for example, Sr_{0.88}Y_{0.08}TiO₃. In some cases, the material may have a formula Sr_{1-y}YₓTiO₃, where x may be between about 0.06 and about 0.1, between about 0.01 and about 0.5, between about 0.1 and about 0.5, between about 0.02 and about 0.4, or between about 0.2 and about 0.4 in some cases. In certain embodiments, y may be between x and 2x (for example, 1.5x). z may be between 0 and 1. YST materials may also have reduced electrode polarization in some cases. In some embodiments, the YST material may be prepared by doping SrTiO₃ with yttrium. Such a YST material may have a relatively high electronic conductivity at an elevated temperature, for example, an electronic conductivity of about 50 S/cm to about 80 S/cm at a temperature of 800° C. and an oxygen partial of between about 10⁻¹⁴ and about 10⁻¹⁹ bar. As a particular non-limiting example, a YST material was prepared and sintered at a temperature of 1400° C. X-ray diffraction (“XRD”) analysis of this material showed no evidence of reactions (FIG. 3), and analysis via SEM showed excellent densification. In FIG. 3, the upper graph shows an XRD pattern for a 50/50 wt % YST-8YSZ material that was sintered at 1400° C. for 5 hours. The two smaller graphs (below) show the XRD patterns of the two individual components based on known standards of isolated YST and isolated YSZ. Each line in the top graph is found back on either of the two smaller graphs, and therefore it can be concluded that there are no new compounds formed in this example that could be detected using XRD.

In another embodiment, the ceramic electronic conductor may comprise a material comprising a LST (La—Sr—Ti) material, i.e., a ceramic material comprising La, Sr, Ti, and O. Such materials can be produced, for instance, by doping SrTiO₃ with a lanthanum oxide. The LST material may have a formula Sr_{1-y}LaₓTiO₃ in some embodiments, where x may be between about 0.01 and about 0.6, between about 0.02 and about 0.5, between about 0.04 and about 0.4, between about 0.1 and about 0.5, or between about 0.2 and about 0.4 in some cases. In some embodiments, y may be between x and 2x, for example, about 1.5x. For example, the lanthanum oxide may be added at a dopant at concentrations of between about 20 mol % La and about 40 mol %.

In yet another embodiment, the ceramic electronic conductor may be both an LST and a YST material (a “YLST” material), i.e., the ceramic material comprises Y, La, Sr, Ti, and O. The YLST material may have a formula Sr_{1-y}(Y_{z}La_{1-z})ₓTiO₃, where x may be between about 0.01 and about 0.5, between about 0.1 and about 0.99, between about 0.1 and about 0.5, between about 0.02 and about 0.4, between about 0.2 and about 0.4, or between about 0.2 and about 0.9 in some cases; y may be between x and 2x, for instance, about 1.5x; and z may be any number between 0 and 1, for example, 0.25, 0.5, 0.75, etc. In still other embodiments, the material may comprise a strontium titanate doped with one or more of Y, Sc, Ce, La, Nb, Yb, Gd, Sm, and Pr. For example, in one embodiment, the material has a formula A_{1-y}SrₓTiO₃, or A_{1-y}SrₓTiO₃, where A represents one or more atoms, each independently selected from the group consisting of Y, Sc, Ce, La, Nb, Yb, Gd, Sm, or Pr, and x may be between about 0.01 and about 0.5, between about 0.1 and about 0.99, between about 0.1 and about 0.5, between about 0.02 and about 0.4, between about 0.2 and about 0.4, or between about 0.2 and about 0.9 in some cases; y may be between x and 2x, for example, about 1.5x. For instance, A_{1-yx} or A_{1-1.5x} in these structures may represent A¹ₐ_{₁} (i.e., A¹_{1-yx}LaₓTiO₃), A¹ₐ_{₁}A²ₐ₂ (i.e., A¹ₐ_{₁}A²ₐ_{₂} LaₓTiO₃), A¹ₐ_{₁}A²ₐ_{₂}A³ₐ_{₃} (i.e., A¹ₐ_{₁}A²ₐ_{₂}A³ₐ_{₃} LaₓTiO₃), . . . , etc., where each of A¹, A², A³, . . . , etc. is independently selected from the group consisting of Y, Sc, Ce, La, Nb, Yb, Gd, Sm, or Pr, and each of a₁, a₂, a₃, . . . , etc. sums to 1-y or 1-x. In some cases, the coefficients are chosen to achieve charge neutrality.

In yet another embodiment, the ceramic electronic conductor may comprise a ceramic material comprising Y, Ti, O, and a Group 2 element, for example, one or more of Be, Mg, Ca, Sr, and/or Ba. For example, the ceramic material may have a formula Mg_{0.88}Y_{0.08}TiO₃ or Ca_{0.88}Y_{0.08}TiO₃.

In still another embodiment, the ceramic electronic conductor comprises a ceramic material comprising La, Ti O, and a Group 2 element, for instance, one or more of Be, Mg, Ca, Sr, and/or Ba. Such materials can be produced, for instance, by doping a Group 2 titanium oxide material with a lanthanum oxide to produce a doped Group 2 titanium oxide material. The material may have a formula E_{1-y}LaₓTiO₃ in some embodiments, where E represents one or more atoms, each independently selected from the Group 2 elements, for example, one or more of Be, Mg, Ca, Sr, and/or Ba. In certain embodiments, x may be between about 0.1 and about 0.99, or between about 0.2 and about 0.9, etc., and y may be between x and 2x, for instance, about 1.5x.

In yet other embodiments, the ceramic electronic may include one or more of the above materials. For instance, the ceramic material comprises Y, La, Ti, O, and a Group 2 element, for example, (Y_{z}E_{1-z})_{1-y}LaₓTiO₃, where E represents one or more atoms, each independently selected from the Group 2 elements. In some embodiments, x may be between about 0.1 and about 0.99, or between about 0.2 and about 0.9 in some cases; y may be between x and 2x, for instance, about 1.5x; and z may be any number between 0 and 1, for example, 0.25, 0.5, 0.75, etc. In still other embodiments, the material may comprise a Group 2 titanate doped with one or more of Y, Sc, Ce, La, Nb, Yb, Gd, Sm, and Pr. For example, in one embodiment, the material has a formula A_{1-y}EₓTiO₃, where A represents one or more atoms, each independently selected from the group consisting of Y, Sc, Ce, La, Nb, Yb, Gd, Sm, or Pr; E represents one or more atoms, each independently selected from the Group 2 elements; x may be between about 0.1 and about 0.99, or between about 0.2 and about 0.9 in some cases; y may be between x and 2x, for instance, about 1.5x; and A_{1-y} is as discussed above.

As noted above, the invention provides materials in which both the electrically and ionically conducting phases perform well, and this generally means provision of a good network of interconnected, continuous ionically and electrically conductive pathways, respectively, throughout the material. Ratios of phases relative to each other (where two-phase materials are provided) are described above in this regard. Another factor which those of ordinary skill in the art can adjust based on the present disclosure, to achieve good conductivity, is the density of the material, and/or the porosity. A more dense material will, in general, include more contact between individual portions of material phases (e.g., grains of ceramic), maximizing the presence of continuous conductive pathways of each. For example, in certain cases, the mixed ionically and electrically conducting material may have a density of at least about 80%. For example, the density of the material may be at least about 85%, at least about 90%, or at least about 95%, as measured on a volumetric basis. Those of ordinary skill in the art will know of suitable techniques for measuring the relative density of a material on a volumetric basis.

In some embodiments, the mixed ionically and electrically conducting material is substantially non-porous, i.e., the porosity of the material is less than about 1 open pore/mm², and this can improve ionic and/or electrical conductivity. For example, the material may have a porosity of less than about 1 open pore/mm² less than about 1 open pore/cm² or the like. “Open pores” can be measured in a material by creating a pressure differential from one side of the material to the other side that is at least about 5 psi (34.5 kPa), coating the lower-pressure surface with a thin film of a liquid such as alcohol, and determining the number of bubbles that are created due to the pressure differential, where the presence of a stream of bubbles indicates the presence of an open pore. Another example method of determining porosity is a helium leak test, where a leak rate in the order of at most 0.01 cm³/min of helium per cm² of cell area and per psi of pressure would be required (1 psi is about 6.9 kilopascals (kPa)).

Combinations of density, non-porosity, ratio of ionically to electrically conductive phase, and/or other adjustments can be made based on this disclosure to tailor combined conductivity of material, i.e., combined (ionic and electrical) resistivity. For example, the material may have a resistivity of less than about 1000 Ohm cm (Ω cm), less than about 750 Ohm cm, less than about 500 Ohm cm, less than about 250 Ohm cm, less than about 200 Ohm cm, less than about 150 Ohm cm, less than about 100 Ohm cm, etc.

The material may also be substantially gas impermeable in certain cases, i.e., the material can be used to maintain separation of a first gas in a first compartment of a chamber on one side of the material and a second gas in a second compartment on another side of the material (for example, with compartments being on each side of the material, as illustrated schematically in FIG. 2A), both gases being at ambient pressure (about 1 bar). For example, the ionically and electrically conducting material may be sufficiently gas impermeable that, if two gases are placed on either side of a mixed ionically and electrically conducting material, less than about 5% of the gases, less than about 3%, or less than about 1% of the gases on either side of the material are able to mix after a period of at least a day. In some cases, no mixing of the gases can be detected after a day.

In other embodiments, however, the material is porous, and allows at least some gas to be transported therethrough. In some cases, the material may be selectively permeable, that is, permeable to some but not other gases. For example, the material may be permeable to hydrogen gas, but impermeable to other gases. In one embodiment, the material is sufficiently porous that pressure differences between a first side and a second side of the material may be used to direct the transport of gas across the material, e.g., from a higher pressure to a lower pressure. In other embodiments, the material is gas impermeable at ambient pressure, but at higher pressures, the material may be permeable or selectively permeable to gases.

In one set of embodiments, the invention provides structures using mixed ionically and electrically conducting materials. For example, the mixed ionically and electrically conducting material can be positioned in contact with a substrate, such as a porous substrate. The porous substrate may have a porosity that is at least sufficient to allow access to the material by gases such as oxygen, hydrogen, and/or water vapor, while providing at least some mechanical stability of the material, for instance, if the mixed ionically and electrically conducting material is present as a thin layer, for example, having a thickness of less than about 50 micrometers, for instance, between about 10 and about 20 micrometers or between about 10 and about 40 micrometers. The material, at these or other thicknesses, also may have a particularly high overall aspect ratio, i.e., its thickness may be quite small relative to another dimension perpendicular to the thickness, or to two other dimensions each perpendicular to the thickness. Where aspect ratio is defined as the ratio of at least one dimension perpendicular to thickness, to the thickness itself, mixed conductive material of the invention having an aspect ratio of at least about 5:1, 10:1, 20:1, 50:1, or 100:1 may be provided, optionally with an adjacent, supporting substrate that can be porous (e.g. in a layered arrangement). The material and/or the substrate may have any shape. For example, in one embodiment, the material is deposited on the outside of a substrate that is a porous tube. In another embodiment, the material is deposited on the surface of a planar porous substrate. The porous substrate may be any suitable porous material, for example, a ceramic, a polymer, or a metal.

Accordingly, in one set of embodiments, a mixed ionically and electrically conducting material, which can be ceramic, is provided having a first side and a second opposing side, one or both sides addressed by a porous, supporting layer. One or more of the porous, supporting layers can, itself, be a mixed ionically and electrically conducting material, or simply ionically conductive or or electrically conductive, and each can, in some cases, be supported by an auxiliary, porous, inert layer. In one such arrangement, a multi-layer structure exists, comprising a first, porous layer, and a second, ceramic, dense mixed conduction material. In another arrangement, the multi-layer structure comprises first, porous layer, a second, ceramic, dense mixed conduction material, and a third, porous layer. In yet another arrangement, the multi-layer structure comprises a first, porous layer, a second, porous mixed conduction material, a third, ceramic, dense mixed conduction material, and a fourth porous mixed conduction material. In another arrangement, a multi-layer structure exists, comprising a first, porous layer, a second, porous mixed conduction material, a third, ceramic, dense mixed conduction material, a fourth, porous mixed conduction material, and a fifth, porous layer.

In some cases, e.g., if the surface of the deposited material is too “smooth,” an additional layer of powder may be added to the surface of the mixed conducting material that has been deposited on the porous substrate. For example, the powder may be a powder of the mixed conducting material, which can be deposited on a surface of the mixed conducting material, or another type of powder. In one embodiment, the additional layer of powder is deposited using vacuum intrusion, which may also assist in reducing polarization of the powder in some cases.

In another aspect of the invention, hydrogen, for example substantially pure hydrogen gas, is produced using a reactor containing a mixed ionically and electrically conducting material, such as those described herein. For example, with reference to FIG. 2B, a mixed ionically and electrically conducting material 10 may be used to separate first compartment 21 and second compartment 22. In compartment 21, a fuel is oxidized, for example, to produce an oxidized fuel, which may be partial or complete oxidation, e.g., to water, carbon dioxide, SO₂, etc., while in compartment 22, a reduction reaction occurs, for example, water is reduced to produce hydrogen gas, i.e., in situ electrolysis.

Oxygen that is produced from the reduction of water to hydrogen gas (or other reduction reaction) is transported across material 10 from compartment 22 to compartment 21, where it can react with the fuel, while electrons that are generated from the oxidation of the fuel return across material 10 to participate in the reduction of water to hydrogen gas. The hydrogen gas produced in this reaction may be separated and isolated, and/or routed to devices that can consume hydrogen, for example, fuel cells as discussed in detail below. Thus, in certain embodiments, a reactor of the invention may oxidize a fuel and simultaneously produce hydrogen gas within the same reactor. In some cases, the hydrogen can be consumed to produce power.

In some embodiments, the oxygen used to oxidize the fuel comes only from the mixed conducting material at steady state, although additional oxygen may be added for start-up and/or thermal balance requirements. In other embodiments, however, additional oxygen may be supplied even during steady state, for example, if more complete oxidation of the fuel is desired, if higher reaction temperatures are needed, etc.

The hydrogen gas produced by the reactor may exit the reactor in a first stream, while waste gases produced from the oxidation of the fuel may exit the reactor in a second stream, and/or be used in other operations within the reactor. The hydrogen gas that is produced by the reactor is thus substantially pure and free of contaminants (gaseous, particulate, etc., e.g., which may be present within the fuel), as the hydrogen gas is produced in a physically separate compartment than the compartment where the fuel has been oxidized. Such a physically separate arrangement may be advantageous, for example, in embodiments where impurities or other components of the fuel could harm or foul the reduction of water to hydrogen gas. Thus, a substantially pure hydrogen stream can be produced in some embodiments. For example, the substantially pure hydrogen stream may be at least about 90%, at least about 95%, at least about 97%, at least about 98%, or at least about 99% pure on a volumetric basis. In other embodiments, however, some water may be present within the hydrogen stream exiting the reactor (i.e., a “wet hydrogen” stream). Of course, in such cases, such a wet hydrogen stream may optionally be subsequently separated into water and hydrogen gas, before and/or after leaving the reactor, for example, using a condensation operation.

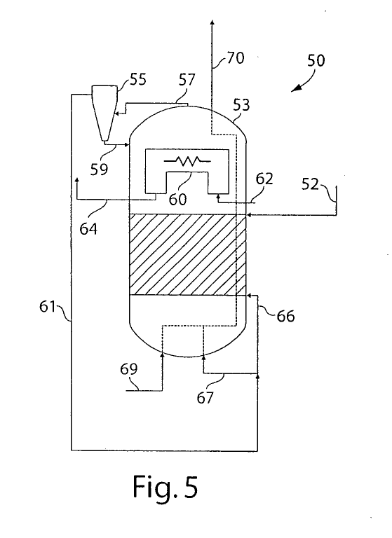

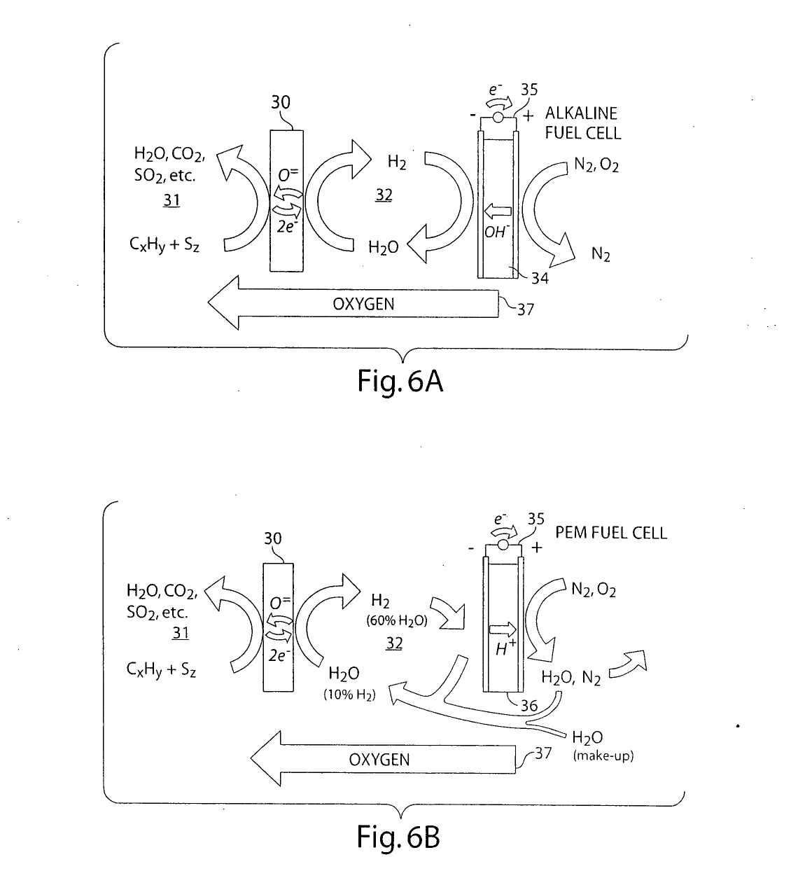

In some cases, the waste gases may be recycled within the reactor, for example, to facilitate gasification of a fuel, for instance, a carbonaceous fuel such as coal. Examples of recycling processes are illustrated in FIGS. 4 and 5. In one embodiment, partially oxidized fuels exiting the reactor may be recycled to effect further oxidation. In another embodiment, waste gases such as water and carbon dioxide are used as reactants for the gasification of coal according to the following endothermic reactions:

C+CO₂⇄2CO ΔH=+170 kJ/mol at 800° C.

C+H₂O⇄CO+H₂ ΔH=+136 kJ/mol at 800° C.

In some embodiments of the invention, the same pressure is used on both sides of the mixed conducting material. However, in other embodiments of the invention, the pressures on the material are not necessarily the same. For example, in some cases, the pressure within the water-hydrogen reaction compartment may be greater, while in other embodiments, the reaction in this compartment may be less than the pressure in the fuel oxidation compartment. In certain cases, one or both pressures on the material may be ambient pressure. Even if the material is porous and/or at least partially selectively permeable, substantially pure hydrogen gas can still be produced, for example, if the pressure in the water-hydrogen reaction compartment is greater than the pressure in the fuel oxidation compartment such that gases from the fuel oxidation compartment are not able to cross the material due to the pressure difference.

The reactor, as described above, does not necessarily require a water-gas shift reaction that produces hydrogen gas directly from syngas, and therefore raw gasified carbonaceous fuel streams can be oxidized to produce hydrogen gas, in contrast to prior art systems where a fuel or syngas stream needs to be additionally processed to be free of contaminants such as H₂S, which can poison catalysts in those prior art systems. In certain embodiments, the reactor can be placed within a gasifier compartment itself (i.e., the compartment in which a carbonaceous fuel is reacted to produce a gasified hydrocarbon, such as syngas), for instance, as is illustrated in the example shown in FIG. 5, and discussed in detail below

It should be noted that the system, as described above, is by way of example only and is not intended to be limiting, and other reactions are also contemplated within the scope of the present invention. For example, any reduction reaction may be used within the reduction compartment, besides the reduction of water to hydrogen gas, that is able to produce ions that can be transported across the mixed conducting material, for example, a reduction reaction that produces oxygen ions, hydrogen ions, or the like. Similarly, other fuels can be used besides carbonaceous fuels within the oxidation chamber, which fuels may produce electrons when oxidized (partially or completely) that can be transported across the mixed conducting material.

Those skilled in the art will recognize that the above-described system will work for any process in which there is an oxidizable species on one side of a mixed conducting material, as disclosed herein, and a reducible species on the other side. Thus, as another example, CO₂ can be reduced to CO on one side of the mixed conducting material, while methane (for instance, from natural gas) may be oxidized on the other side of the mixed conducting material, e.g., as follows:

4CO₂+8e⁻→4CO+4O²⁻ cathode

CH₄+4O²⁻→CO₂+2H₂O+8e⁻ anode

In one set of embodiments, the flow within the reactor of the oxidizable species (e.g., a fuel) and the reducible species (e.g., water) may be co-current, e.g., the flow of both species across the mixed conducting material occurs in substantially the same direction. In other embodiments, however, the flow may be counter-current (e.g., the flow of both species is in substantially opposite directions) or cross-current (e.g., the flow of both species is not co-current nor counter-current flow). Counter-current flow may give certain advantages, for example, greater efficiency, or better purity of the resultant streams after reaction, relative to co-current or cross-current flow. For instance, in counter-current flow, an oxidiziable species entering the reactor may be substantially oxidized upon leaving the reactor (e.g., by being in electronic/ionic communication with a substantially unreduced reducible species near the outlet for the oxidizable species), while a reducible species entering the reactor may be substantially reduced upon leaving the reactor (e.g., by being in electronic/ionic communication with a substantially unoxidized oxidizable species near the outlet of the reducible species).

One non-limiting example of such a reactor is shown in FIG. 4, in which reactor 50 comprises several different units or vessels therein. In the arrangement illustrated schematically in this figure, water and a fuel source, such as coal, are fed to reactor 50, and are reacted to produce hydrogen gas and waste gases, such as CO₂. Coal is fed in coal feed 52 to gasifier 53. Of course, in other embodiments, other fuels may be used instead or in addition to coal, for example, carbonaceous fuels such as those previously described. Within the gasifier, the coal (or other fuel) is broken down and fluidized to produce a hydrocarbon stream, e.g., a stream comprising a mixture of water, CO, CO₂, lower hydrocarbons (e.g., organic molecules containing fewer numbers of carbon than initially fed to the gasifier, for example), unreacted hydrocarbons, and/or other compounds, such as impurities, inorganic entities, or the like. In some embodiments, the gasification is conducted in such a manner that a syngas is formed.

Typically, the hydrocarbon stream will include impurities, unreacted fuel, and the like. In some cases, these may be present as particles within the stream. In some cases, these may be removed from the hydrocarbon stream using separation techniques known to those of ordinary skill in the art, for example, using filters, cyclones, centrifugal separators, impingement separators, or the like. For example, as is shown in FIG. 4, a cyclone 55 is used to separate a hydrocarbon stream 57 produced in gasified 53 from various impurities, unreacted fuel, etc. Optionally, the impurities, unreacted fuel, etc. may be fed back to gasifier 53 in stream 59.

The hydrocarbon stream, upon leaving cyclone 55, flows through stream 61 to reaction chamber 60. Also entering reaction chamber 60 is stream 62. Stream 62 contains water, for example, which may be present as steam. Reaction chamber 60 contains a mixed conducting material which separates the reaction chamber into two (or more compartments), at least one of which is fed by stream 61 and at least one of which is separately fed by stream 62. Within reaction chamber 60, the hydrocarbon stream is oxidized, for example, completely to produce CO₂, while the water is reduced to H₂, e.g., using the reaction schematic illustrated in FIG. 2B. H₂ (which may or may not include water) leaves the reactor through stream 64 (and can be collected and/or purified), while the oxidized fuel leaves the reactor through stream 63. In some cases, heat may be exchanged between streams 62 and 64, e.g., using a heat exchanger as is indicated by heat flow 68, which may increase the overall efficiency.

In some embodiments, depending on the efficiency of reaction chamber 60, a scrubber and/or an absorbent bed (not shown) may be added to stream 63. Stream 63, upon exiting reaction chamber 60, is fed back to gasifier 53. This creates a recycling operation that may increase the overall efficiency of the system. In the example shown in FIG. 4, stream 63 divides into streams 66 and 67. Stream 66 is fed to the coal bed, being the gasification agent for the next cycle, and stream 67 is fed to a burner where the remaining CO burns with oxygen or air, introduced through stream 69. This is indicated by the dotted lines within the gasifier 53, which represents, for instance, a tube bundle in the reactor, through which combustion products may flow. These give off heat to the gasifier, which may assist the endothermic gasification process. The gases then exit the gasifier 53 in stream 70, which may include waste gases such as CO₂, H₂O, and the like. In some cases, the CO₂ may be further processed and/or sequestered.

Another example of an embodiment of the invention is shown in FIG. 5. In this figure, although the arrangement is similar to that shown in FIG. 4, here, the reaction chamber 60 is now positioned internally of gasifier 53. As before, water (steam) is fed to reaction chamber 60, which is isolated from gasifier 53 through the use of a mixed conducting material. However, instead of a separate hydrocarbon stream as was shown in FIG. 4, in the embodiment shown in FIG. 5, the fuel within gasifier 53 is directly exposed to the mixed conducting material. Such an arrangement may yield additional efficiency, as the heat lost from the reaction chamber is utilized within gasifier 53.

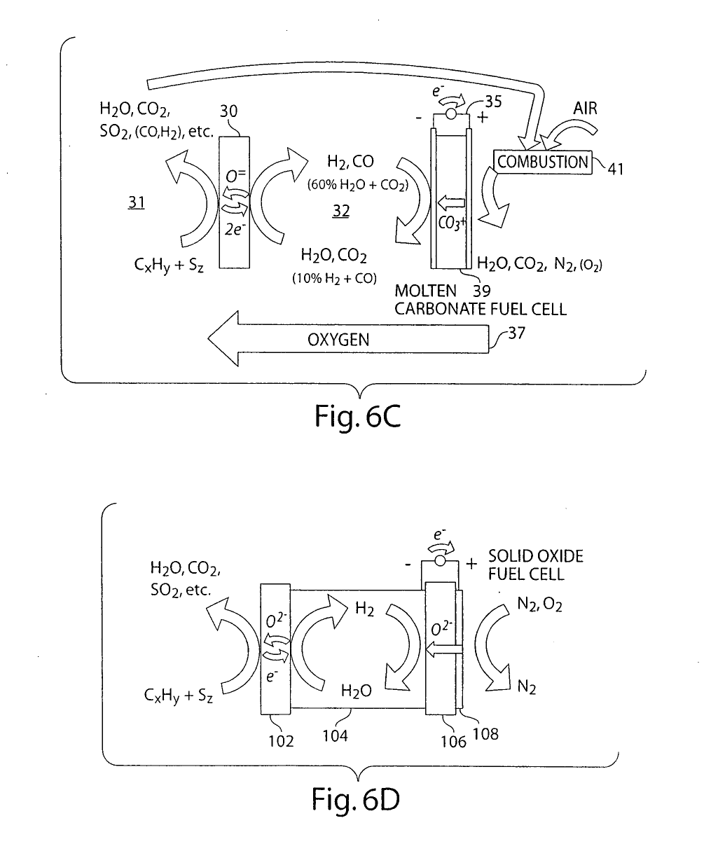

The hydrogen gas produced using techniques such as those described above may be separated from the reactor, e.g., for use in reactions or power generation, or in some aspects of the invention, the hydrogen gas may be oxidized to produce electrical power, for example, in a fuel cell. In some cases, the process of power generation may occur simultaneously with hydrogen gas production. Any suitable system that can react hydrogen gas to produce water and power may be used, for example, fuel cells. Non-limiting examples of fuel cells include solid oxide fuel cells, molten carbonate fuel cells, phosphoric acid fuel cells, polymer electrolyte fuel cells (e.g., using proton exchange membranes), alkaline fuel cells, or the like. Thus, in one embodiment, hydrogen is provided in a reactor (e.g., supplied externally as a fuel, and/or produced by the reactor), which is reacted in a first portion of a reactor to produce water, and then re-converted to hydrogen in a second portion of the reactor. The hydrogen may be re-cycled back to the first portion of the reactor, e.g., as is shown in FIGS. 6A-6D, and/or the hydrogen may be separated as described above, or even used as a fuel for an electrochemical device not involving either the first or second portions, as a reactant for a chemical process, or the like. The first portion and second portion may be contained within the same chamber or vessel, or the first and second portions may be in separate vessels that are in fluidic communication, e.g., using pipes, tubing, conduits or the like, for example, a first vessel may contain a mixed conduction material (e.g., as described herein) and a second vessel may contain a fuel cell, a vessel may contain therein both a mixed conduction material and a fuel cell (e.g., such that hydrogen and/or water within the vessel is in fluid communication with both the mixed conduction material and the fuel cell), or the like. Those of ordinary skill in the art will be able to engineer and build suitable systems using no more than routine skill with the disclosures described herein, for example, by adding, as appropriate, reaction vessels, piping, tubing, heat exchangers, gas collection systems, and the like.

FIGS. 6A-6C illustrates several general reaction schemes, using a mixed conduction material of the invention 30, together with a fuel cell. In these figures, both electrons (e⁻) and oxygen (O²⁻ or O⁻) can be transported across mixed conduction material 30, which separates an oxidation compartment 31 from a reduction compartment 32. On one side of material 30, a fuel, such as a carbonaceous fuel, optionally comprising sulfur or other impurities (represented as CₓH_{y}+S_{z}) can be completely oxidized to produce H₂O, CO₂, SO₂, etc. In other embodiments, however, the fuel may be only partially oxidized. The oxidation reaction also produces electrons, which are transported across the mixed conduction material 30. The electrons are used in a reduction reaction, e.g., reacted with water (H₂O) to produce hydrogen gas (H₂) and oxygen ions. The ions can be transported across mixed conduction material 30.

The hydrogen gas may be used to regenerate water in the fuel cell, optionally producing electric current in the process, which may be harnessed. The fuel cell may be separate from the reactor where hydrogen is produced from water, for example, contained within a compartment or a vessel that is physically separate from, but is in fluidic communication with, the compartment in which hydrogen is produced from water; or in some cases, the fuel cell may be an integral part of the reactor, i.e., in a compartment of the reactor, a mixture of hydrogen and water (which may be present as steam) is simultaneously exposed to a reaction in which hydrogen is produced from water (e.g., using a mixed ionically and electrically conducting material, as previously described), and a reaction in which water is produced from hydrogen (e.g., in a fuel cell). The fuel cell may react H₂ to produce water (H₂O) by reaction with hydroxide ions (OH⁻), oxygen ions (O²⁻), carbonate ions (CO₃²⁻), etc., which in the process, may release electrons that can be harnessed as power 35.

It should be noted that the net result of such a reaction system, as is shown in FIGS. 6A-6D, is that oxygen enters the fuel cell, and, through a series of reactions, reacts with and oxidizes the fuel. Thus, there is a net transport of oxygen through this reaction system, as is shown by arrow 37.

In FIG. 6A, as an example, an alkaline fuel cell is demonstrated, where OFF is transported through the fuel cell to reduce hydrogen gas to water (H₂+2OH—→2H₂O+2e⁻), in the process generating electrons which are harnessed. The OH⁻ may come from a source such as pure oxygen source, or from air (as is shown in FIG. 6A) or another source comprising oxygen, for example, produced using water in the reaction (O₂+2H₂O+4e⁻→4OH⁻). In some cases, the alkaline fuel cell uses a matrix 34 saturated with an aqueous alkaline solution, such as potassium hydroxide (KOH), in which the OH⁻ is transported.

In FIG. 6B, a fuel cell using a proton exchange membrane is demonstrated. In this fuel cell, protons can be transported through the proton exchange membrane, although electrons cannot. Thus, while protons (H⁺) passes through the membrane, the electrons must pass through an external circuit, where they can be harnessed for power 35. In this system, some of the hydrogen gas within compartment 32 is broken down to produce the H⁺ which is transported through the proton exchange membrane. Consequently, make-up hydrogen may be added to compartment 32, e.g., as hydrogen gas and/or as water. Upon exiting the proton exchange membrane, the H⁺ is reacted, for example, with oxygen (e.g., in air) to produce water. Proton exchange membranes are well-known in the art and can be made, for example, from certain polymers as the electrolyte/membrane 36.

FIG. 6C shows a molten carbonate fuel cell, as yet another example. In the molten carbonate fuel cell, the electrolyte 34 comprises a molten carbonate salt mixture, which may be suspended in a porous ceramic matrix 39, for example, a lithium aluminum oxide (LiAlO₂) matrix. A fuel is combusted 41, for example, in air, and the combustion products are exposed to the molten carbonate fuel cell. Optionally, the combustion processes are recycled from compartment 31, as is indicated by arrow 42. Carbonates are produced in the matrix, which are then transported to compartment 32. H₂O and/or CO₂ within compartment 32 are reduced as is previously described, e.g., to H₂ and/or CO, respectively. The H₂ and/or CO may then react with the carbonates from matrix 39 to regenerate H₂O and/or CO₂, respectively. It should be emphasized that, in some embodiments, no H₂/H₂O is necessary, and only CO/CO₂ is used as the redox species within compartment 32.

Another non-limiting example is shown in FIG. 6D. In this figure, reactor 100 includes a mixed conduction material 102, an anode 104, an electrolyte 106, and a cathode 108. Anode 104, electrolyte 106, and cathode 108 together form a fuel cell, for example, a solid oxide fuel cell. Within reactor 100, oxygen (e.g., from air) is transported through electrolyte 106 to anode 104. In some cases, anode 104 is a liquid anode. Within anode 104, the oxygen ions react with hydrogen to produce water. The hydrogen may originate from within reactor 100, and/or the hydrogen may be externally supplied. The water produced in this reaction is then reduced at mixed conduction material 102, producing oxygen which is transported through mixed conduction material 102 to oxidize a fuel, for example, a carbonaceous fuel (represented in FIG. 6D by CₓH_{y} and S_{z}).

It should be noted that these figures are intended to be schematic representations of useful general reaction schemes, and have been simplified for clarity. The reactions shown in FIGS. 6A-6D may occur in one or more vessels or housings, for example, the mixed conduction material and the fuel cell may be contained within a single vessel or housing, or the mixed conduction material may be contained in a first vessel and the fuel cell may be contained in a second vessel or housing physically separated but in fluidic communication with the first vessel or housing, for example, using pipes, tubing, conduits, or the like.

The following examples are intended to illustrate certain embodiments of the present invention, but do not exemplify the full scope of the invention.

### EXAMPLE 1

In this example, the hydrogen yield from a ceramic that is used to separate an oxidizable species on one side and a reducible species on the other side (see FIG. 2), is calculated. The ceramic is short circuited by the electron flow.

In such cases, an electrical current, I, according to Ohm's law, may be expected:

$$I = \frac{V}{R} .$$

The voltage V can be calculated from the ratio of partial oxygen pressures on either side of the membrane using the Nernst equation. The resistance, R, can be divided into at least the following components: (1) a polarization resistance on the cathode due to the charge transfer, R_{c}; (2) an ohmic resistance resulting from the ionic transport through the membrane, Rᵢ; (3) a polarization resistance on the anode due to the charge transfer, Rₐ; and (4) an electronic resistance that short circuits the cell, Rₑ:

R=R_{c}+Rᵢ+Rₐ+Rₑ

The electronic resistance, Rₑ, can be made negligible relative to R, in some embodiments, by an appropriate choice of ionic and/or electronic materials. The ionic resistance can depend on the material used, and may form a substantial proportion of R. It can be minimized, for example, by reducing the thickness to the minimum that is practically and reliably achievable from a ceramic processing standpoint. The polarization resistances may depend on the surface characteristics. Strategies to minimize these include increasing the reaction contact area, e.g., by using fine powders with catalytic properties. As a specific example, in some cases, an area specific total resistance of 400 mΩ cm² (milliohm-cm²) can be achieved. At a Nernst voltage of 200 mV, this resistance results, based on these calculations, in a current of 0.5 A/cm², which translates into a yield of 3.5 ml H₂/cm²/min (volume measured at 1013 mbar and 273.15 K).

As a specific, non-limiting example, an estimate for the thickness of a particular membrane can be determined as follows. For the ionic conductivity, it can be assumed that the conductivity of ZrO₂ stabilized with 8 mol % Y₂O₃ (8YSZ) at 800° C. is 0.024 S/cm. The presence of an electronic phase may dilute the ionic phase in some instances, which may have a significant effect on the effective conductivity. For example, in some cases, the electronic phase may constitute 50% of the volume; this may reduce the effective ionic conductivity to 30% of the ionic conductivity of the undiluted material. In such a case, a membrane thickness of 30%×400 mΩ cm²×0.024 S/cm=32 microns would be required. Ceramic membranes of this thickness and below can reliably be made at acceptably low leak rates.

The polarization resistance may include the remainder of the total resistance. At high temperatures (e.g., about 1000° C.) the kinetics at the reaction interface may be fast enough to be without significant polarization, so that additional catalysts may not be required in some cases. In some cases, however, e.g., at lower temperatures (750° C. to 800° C.), a high surface area coating of the material on the base membrane may also be useful.

### EXAMPLE 2

This example illustrates a reactor according to one embodiment of the invention. The reactor used in this example is schematically shown in FIG. 4. Table 2 shows the mass and energy balances for a 1 MW hydrogen production system. The difference in enthalpy flows between the H₂ line 64 and the steam line 62 in Table 3 is the latent heat value (1 MW) of the produced hydrogen. It has been assumed in this example that in steam line 62 in the table a fraction of hydrogen is present. In a complete system this may be derived from the product stream. In stream a the ratio of CO to CO₂ is set equal to 8. This is the equilibrium value that would be obtained in a gasifier operating at 800° C. in the presence of C, CO, and CO₂.

Going from stream 57 to stream 63, the gas passes through the separator and the magnitude of the CO flow reduces as much as the CO₂ flow increases. The formation of CO₂ might seem rather low in relation to the total flow that enters the separator. This, however, is a result of the fact that the sequence stream 57, stream 63, and stream 66 form a loop, from which only a small amount is taken away during each passage. The reactor in the loop may therefore be exposed to larger flows. Some benefits are that concentration gradients across reactors are reduced and mass transfer is improved. Recycling of anode gas in fuel cell systems is also an example where this takes place.

The reaction equations of the separator in this example indicate that for each CO molecule that is converted, an H₂ molecule is produced. Therefore, the difference in hydrogen flow between the H₂ line and the steam line is equal to the conversion of CO, in this case 4.1 mol/s.

The efficiency of the process in terms of the latent heats of the net hydrogen produced, relative to the carbon consumed is (see Table 2):

$$ɛ = \frac{Δ {φ}_{H 2} Δ {H}_{H 2}}{{φ}_{c} Δ {H}_{c}} = \frac{( 4.3 - 0.17 ) * 242}{3.16 * 400} = 80 \% ,$$

where ΔH_{c}=−400 kJ/mol is the combustion heat of carbon, ΔH_{H2}=−242 kJ/mol is the heat of combustion of hydrogen (latent heat of vaporization values at 20° C.). The free enthalpy flux ratio of the net produced hydrogen stream and the ingoing carbon stream is equal to (see Table 3):

$${ɛ}_{G} = \frac{Δ {φ}_{H 2} Δ {G}_{H 2}}{{φ}_{c} Δ {G}_{c}} = \frac{( 4.3 - 0.17 ) * 228}{3.16 * 395} = 75 \% ,$$

where ΔG_{c}=−395 kJ/mol is the free enthalpy change of the oxidation of carbon, and ΔG_{H2}=−228 kJ/mol is the free enthalpy change of the oxidation of hydrogen, both at 20° C.

The free enthalpy change is the theoretical maximum amount of work (mechanical, electrical) that can be obtained from a reaction, according to this example. Therefore the above quotient identifies how much of the resulting work potential is still available relative to the work potential before the gases entered the system.

TABLE 2

| | C | | | | | | line | line | line | heat | |
|---|---|---|---|---|---|---|---|---|---|---|---|
| | feed | line a | line b | line c | line d | steam | H₂ | CO₂ | O₂ | out | units |
| CO | 0 | 18.7 | 14.6 | 12.4 | 2.2 | 0 | 0 | 0 | 0 | | mol/s |
| CO₂ | 0 | 2.4 | 6.5 | 5.5 | 1.0 | 0 | 0 | | 0 | | |
| H₂ | 0 | 0 | 0 | 0 | 0 | 0.17 | 4.3 | 0 | 0 | | |
| H₂O | 0 | 0 | 0 | 0 | 0 | 17.0 | 12.9 | 0 | 0 | | |
| C | 3.16 | 0 | 0 | 0 | 0 | 0 | 0 | 3.16 | 0 | | |
| O₂ | 0 | 0 | 0 | 0 | 0 | 0 | 0 | 0 | 2.2 | | |
| enthalpy flux | 0 | −3.0 | −4.1 | −3.5 | −0.6 | −4.1 | −3.1 | −1.2 | 0 | 0.2 | MW |

Table 3 shows the partial oxygen pressures in the streams to and from the separator and the resulting voltages that drives the oxygen ions through the membrane for this example. On the cathode side, i.e. the hydrogen side, there is a pO₂ gradient ranging from 4.3×10⁻¹⁵ bar to 4.0×10⁻¹⁸ bar, going from inlet to outlet. This is representing an upgrade of the hydrogen content from 1% to 25%. As can be seen from the voltages in Table 4, a strong driving force is available down to pO₂=4×10⁻¹⁸ bar. Increasing the hydrogen content to 50% brings the pO₂ down to 8.9×10⁻²⁰, leaving substantially less driving force (only 65 mV). This would reduce the yield of the membrane reactor, but would also lessen the steam production requirement per unit volume of hydrogen produced.

TABLE 3

| Driving force | | pO₂ cathode | pO₂ anode |
|---|---|---|---|
| Voltage | 256 mV | 4.3 × 10⁻¹⁵ | 7.7 × 10⁻²⁰ |
| line a—steam | | | |
| Voltage | 153 mV | 4.0 × 10⁻¹⁸ | 6.1 × 10⁻²¹ |
| line b—line H₂ | | | |

### EXAMPLE 3

The following example illustrates the production of a mixed ionically and electrically conducting ceramic for use in a reactor, according to one embodiment of the invention.

Initially, a support tube was extruded and dried. The support tube is formed from Ni-YSZ, although the extrusion dough may contain, besides the Ni-YSZ precursors, binders, pore-formers etc. The Ni-YSZ tube was extruded using standard extrusion techniques known to those of ordinary skill in the art. The tube had a wall thickness of 1 mm and a diameter (green) of 9 mm. The tube was allowed to dry and harden before next step.

Next, a caps were added to the tube. The caps were circles cut from a green Ni-YZY sheet, and glued onto ends of tubes to form caps using Ni-YSZ slurry in a solvent. The cap was then bisque fired in air for 2 hours at 1100° C. An inner functional layer was then applied, after the tube had cooled. The functional layer was prepared by dip-coating the ceramic in a solution comprising Ni-CGO. The inner functional layer could optionally be sintered. In this sintering process, the tube was fired in air for 2 hours at 1100° C.

YSZ/YST was applied to the tube as follows. The tube was dip-coated in a solution comprising 50% YSZ and 50% YST by sintered volume. The YSZ/YST was then fired in air for 5 hours at 1350° C.

An outer functional layer was then applied, after the tube had again cooled. The functional layer was prepared by dip-coating the ceramic in a solution comprising Ni-CGO. The outer functional layer could optionally be sintered. In this sintering process, the tube was fired in air for 2 hours at 1000° C. to 1200° C.

The YST was then reduced at high temperatures. This was performed by firing the tube in hydrogen for 2 hours at 1100° C.

The following documents are incorporated herein by reference: U.S. Provisional Patent Application Ser. No. 60/616,475, filed Oct. 5, 2004, entitled “Conducting Ceramics for Hydrogen Generation,” by Rackey, et al.; U.S. Provisional Patent Application Ser. No. 60/662,321, filed Mar. 16, 2005, entitled “Conducting Ceramics for Electrochemical Systems,” by Rackey, et al.; International Patent Application No. PCT/US2005/035714, filed Oct. 5, 2005, entitled “Conducting Ceramics for Hydrogen Generation,” by Rackey, et al.; U.S. Provisional Patent Application Ser. No. 60/787,555, filed Mar. 30, 2006, entitled “Conducting Ceramics for Electrochemical Systems,” by Rackey, et al.; and U.S. Provisional Patent Application Ser. No. 60/899,865, filed Feb. 6, 2007, entitled “Architectures for Electrochemical Systems,” by Rackey, et al. Also incorporated by reference is a U.S. patent application, entitled “Architectures for Electrochemical Systems” by Rackey, et al., filed on even date herewith.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising acts of:
reacting a fuel comprising hydrogen to generate electricity and water in a first portion of a reactor;
reacting the water to generate hydrogen in a second portion of the reactor; and
reacting at least a portion of the hydrogen generated in the second portion of the reactor to produce electricity.

2. The method of claim 1, wherein the act of reacting the water to generate hydrogen comprises reacting the water with electrons provided by a material comprising a first phase comprising a ceramic ionic conductor and a second phase comprising a ceramic electrical conductor.

3. The method of claim 1, wherein the act of reacting a fuel comprising hydrogen to generate electricity and water comprises reacting the fuel comprising hydrogen in a fuel cell.

4. The method of claim 1, wherein the fuel cell is a solid oxide fuel cell.

5. The method of claim 1, wherein the fuel cell is a proton exchange membrane fuel cell.

6. The method of claim 1, wherein the fuel cell is a molten carbonate fuel cell.

7. The method of claim 1, wherein the fuel cell is a phosphoric acid fuel cell.

8. The method of claim 1, wherein the fuel cell is an alkaline fuel cell.

9. The method of claim 1, wherein the fuel comprises an oxidizable fuel.

10. The method of claim 1, wherein the fuel comprises a carbonaceous fuel.

11. The method of claim 1, wherein the fuel comprises gasified coal.

12. A method, comprising acts of:
reacting a fuel comprising hydrogen to generate electricity and water in a first portion of a reactor;
reacting the water to generate hydrogen in a second portion of the reactor; and
reacting at least a portion of the hydrogen generated in the second portion of the reactor to produce electricity.

13. The method of claim 12, comprising reacting at least a portion of the hydrogen generated in the second portion of the reactor as fuel in the first portion of a reactor.

14. The method of claim 12, wherein the act of reacting the water to generate hydrogen comprises reacting the water with electrons provided by a material comprising a first phase comprising a ceramic ionic conductor and a second phase comprising a ceramic electrical conductor.

15. The method of claim 12, wherein the act of reacting a fuel comprising hydrogen to generate electricity and water comprises reacting the fuel comprising hydrogen in a fuel cell.

16. The method of claim 12, wherein the fuel cell is a solid oxide fuel cell.

17. The method of claim 12, wherein the fuel comprises an oxidizable fuel.

18. The method of claim 12, wherein the fuel comprises a carbonaceous fuel.

19. The method of claim 12, wherein the fuel comprises gasified coal.

20. A method, comprising acts of:
reacting a fuel and water across a mixed ionically and electrically conducting material, wherein the water is isolated from the fuel except for ionic and electronic conduction across the material, to generate hydrogen; and
reacting at least a portion of the hydrogen to produce electricity.

21. The method of claim 20, wherein the act of reacting a fuel and water occurs in a first portion of a reactor, and the act of reacting at least a portion of the hydrogen to produce electricity occurs in a second portion of a reactor.

22. The method of claim 21, wherein the first portion and the second portion are in physically separate compartments that are in fluidic communication.

23. The method of claim 20, wherein the act of reacting at least a portion of the hydrogen to produce electricity comprises reacting at least a portion of the hydrogen to produce electricity and water.

24. The method of claim 20, comprising using at least a portion of the water produced in the act of reacting at least a portion of the hydrogen to produce electricity as the water used in the act of reacting a fuel and water across a mixed ionically and electrically conducting material.

25. The method of claim 20, wherein the mixed ionically and electrically conducting material comprises a ceramic.

26. The method of claim 20, wherein the mixed ionically and electrically conducting material comprises a first phase comprising a ceramic ionic conductor and a second phase comprising a ceramic electrical conductor, the first phase being substantially interconnected throughout the material such that the material is ionically conductive, and the second phase being substantially interconnected throughout the material such that the material is electronically conductive.

27. The method of claim 20, wherein the act of reacting at least a portion of the hydrogen to produce electricity comprises reacting at least a portion of the hydrogen to produce electricity in a fuel cell.

28. The method of claim 27, wherein the act of reacting a fuel and water across a mixed ionically and electrically conducting material occurs in a reactor that is in thermal communication with the fuel cell.

29. The method of claim 27, wherein the fuel cell is a solid oxide fuel cell.

30. The method of claim 27, wherein the fuel cell is a proton exchange membrane fuel cell.

31. The method of claim 27, wherein the fuel cell is a molten carbonate fuel cell.

32. The method of claim 27, wherein the fuel cell is a phosphoric acid fuel cell.

33. The method of claim 27, wherein the fuel cell is an alkaline fuel cell.

34. The method of claim 20, wherein the fuel comprises a carbonaceous fuel.

35. The method of claim 20, wherein the fuel comprises gasified coal.

36. A method, comprising an act of:
reacting water to produce H₂ having a purity of at least about 90% using electrons provided by a material comprising a first phase comprising a ceramic ionic conductor and a second phase comprising a ceramic electrical conductor, the first phase being substantially interconnected throughout the material such that the material is ionically conductive, and the second phase being substantially interconnected throughout the material such that the material is electronically conductive.

37. The method of claim 36, comprising reacting water to produce oxygen ions within the material.

38. The method of claim 37, further comprising reacting the oxygen ions with an oxidizable species.

39. The method of claim 38, wherein the oxidizable species comprises a carbonaceous fuel.

40. The method of claim 38, wherein the oxidizable species comprises gasified coal.

41. The method of claim 36, further comprising oxidizing the H₂ to produce electricity.

42. The method of claim 36, further comprising introducing the H₂ into a fuel cell.

43. The method of claim 36, further comprising reacting the H₂ in a fuel cell to produce water.

44. The method of claim 43, further comprising recycling the water produced by the fuel cell to produce H₂.

45. The method of claim 36, wherein the material is substantially gas impermeable.

46. The method of claim 36, wherein the first phase comprises zirconia.

47. The method of claim 46, wherein the zirconia is stabilized in a cubic structure using one or more dopants.

48. The method of claim 47, wherein the zirconia is stabilized using Y.

49. The method of claim 48, wherein Y is present in a mole ratio of between about 6 mol % and about 10 mol %.

50. The method of claim 47, wherein the zirconia is stabilized using Sc.

51. The method of claim 50, wherein Sc is present in a mole ratio of between about 5 mol % and about 15 mol %.

52. The method of claim 36, wherein the first phase comprises an oxide including at least cerium oxide and gadolinium oxide.

53. The method of claim 36, wherein the first phase comprises a La-ferrite material.

54. The method of claim 36, wherein the first phase comprises Gd₂O₃ doped with Ce.

55. The method of claim 36, wherein the first phase comprises a doped LaFeO₃.

56. The method of claim 55, wherein the doped LaFeO₃ is doped with one or more of Sr, Sc, Ce, Ca, Ga, or Fe.

57. The method of claim 36, wherein the second phase comprises a LST material.

58. The method of claim 36, wherein the second phase comprises a yttrium doped Group 2 titanium oxide.

59. The method of claim 36, wherein the second phase comprises a LCC material.

60. The method of claim 36, further comprising a porous substrate in physical contact with the material.

61. The method of claim 60, wherein the porous substrate is substantially tubular.

62. The method of claim 60, wherein the porous substrate is substantially planar.

63. The method of claim 36, wherein the material is substantially gas-impermeable.

64. The method of claim 60, wherein the material on the porous substrate has a thickness of no more than 200 micrometers.

65. A method, comprising acts of:
reacting a carbonaceous fuel to produce electrons within a material, the material comprising a first phase comprising a ceramic ionic conductor and a second phase comprising a ceramic electrical conductor, the first phase being substantially interconnected throughout the material such that the material is ionically conductive, and the second phase being substantially interconnected throughout the material such that the material is electronically conductive; and
reacting the electrons with water to produce oxygen ions within the material, the oxygen ions being able to react with the carbonaceous fuel.

66. The method of claim 65, wherein the oxidizable species and the water do not come into physical contact.

67. The method of claim 65, comprising reacting the electrons with water to produce H₂.

68. The method of claim 67, further comprising isolating the H₂.

69. The method of claim 68, further comprising oxidizing the H₂ to produce electricity.

70. The method of claim 69, wherein the act of oxidizing the H₂ to produce electricity occurs simultaneously with the act of reacting the electrons with water to produce H₂.

71. The method of claim 65, wherein the carbonaceous fuel comprises gasified coal.

72. The method of claim 65, wherein the first phase comprises YSZ.

73. The method of claim. 65, wherein the second phase comprises a yttrium doped Group 2 titanium oxide.

74. A method, comprising acts of:
reacting an oxidizable species to produce electrons within a material, the material comprising a first phase comprising a ceramic ionic conductor and a second phase comprising a ceramic electrical conductor, the first phase being substantially interconnected throughout the material such that the material is ionically conductive, and the second phase being substantially interconnected throughout the material such that the material is electronically conductive; and
reacting the electrons with a reducible species that is not in physical contact with the oxidizable species to produce H₂.

75. The method of claim 74, wherein the first phase comprises YSZ.

76. The method of claim 74, wherein the second phase comprises a yttrium doped Group 2 titanium oxide.

77. The method of claim 74, wherein the oxidizable species comprises a carbonaceous fuel.

78. The method of claim 74, wherein the oxidizable species comprises gasified coal.

79. The method of claim 74, wherein the reducible species comprises water.

80. The method of claim 74, further comprising reacting the H₂ in a fuel cell to produce water.

81. The method of claim 80, further comprising recycling the water produced by the fuel cell as at least a portion of the reducible species.

82. A reactor, comprising:
a material separating a chamber into a first compartment and a second compartment, the material comprising a first phase comprising a ceramic ionic conductor and a second phase comprising a ceramic electrical conductor, the first phase being substantially interconnected throughout the material such that the material is ionically conductive, and the second phase being substantially interconnected throughout the material such that the material is electronically conductive;
a carbonaceous fuel source in fluidic communication with an inlet of the first compartment; and
a source of water in fluidic communication with an inlet of the second compartment.

83. The reactor of claim 82, wherein the first phase comprises YSZ.

84. The reactor of claim 82, wherein the second phase comprises a yttrium doped Group 2 titanium oxide.

85. The reactor of claim 82, further comprising a first gas in fluidic contact with the material and a second gas, fluidically separated from the first gas, in fluidic contact with the material.

86. The reactor of claim 85, comprising a first compartment containing the first gas, and a second compartment containing the second gas, wherein the material defines a wall separating the first compartment from the second compartment.

87. The reactor of claim 86, wherein the first gas has a higher oxygen partial pressure than the second gas.

88. The reactor of claim 82, wherein the reactor further comprises a fuel cell in fluidic communication with an outlet of the second compartment.

89. The reactor of claim 88, wherein the fuel cell is a solid oxide fuel cell.

90. The reactor of claim 82, wherein the carbonaceous fuel source comprises gasified coal.

91. A system, comprising:
a gasification chamber;
a source of fuel in fluidic communication with the gasification chamber;
a separation chamber, contained within the gasification chamber, fluidically separated from the gasification chamber, at least in part, by a material comprising a ceramic, wherein the material is ionically conductive; and
a source of water in fluidic communication with the second compartment.

92. The system of claim 91, wherein the material is electronically conductive.

93. The system of claim 91, wherein the material comprises a first phase comprising a ceramic ionic conductor and a second phase comprising a ceramic electrical conductor.

94. The system of claim 91, wherein the material comprises a first phase comprising a ceramic ionic conductor and a second phase comprising a ceramic electrical conductor, the first phase being substantially interconnected throughout the material such that the material is ionically conductive, and the second phase being substantially interconnected throughout the material such that the material is electronically conductive.

95. The system of claim 91, wherein the material comprises YSZ.

96. The system of claim 91, wherein the material comprises a yttrium doped Group 2 titanium oxide.

97. An article, comprising:
a substantially non-porous material comprising a first phase comprising a ceramic ionic conductor and a second phase comprising a ceramic electrical conductor, the first phase being substantially interconnected throughout the material such that the material is ionically conductive, and the second phase being substantially interconnected throughout the material such that the material is electronically conductive; and
a porous substrate in physical contact with the material.

98. The article of claim 97, wherein the first phase comprises YSZ.

99. The article of claim 97, wherein the second phase comprises a yttrium doped Group 2 titanium oxide.

100. The article of claim 97, wherein the porous substrate is substantially tubular.

101. The article of claim 97, wherein the porous substrate is substantially planar.

102. An article, comprising:
a first, porous mixed ionically and electrically conducting material; and
a non-porous mixed ionically and electrically conducting material in physical contact with the first, porous mixed conduction material.

103. The article of claim 102, further comprising a second, porous mixed ionically and electrically conducting material in physical contact with the first material.

104. The article of claim 102, further comprising a porous substrate in physical contact with the first material.

105. The article of claim 102, further comprising a porous substrate in physical contact with the non-porous material.

106. The article of claim 102, wherein the non-porous mixed ionically and electrically conducting material comprises a ceramic.

107. The article of claim 102, wherein the non-porous mixed ionically and electrically conducting material comprises a ceramic ionic conductor and a ceramic electrical conductor.

108. A method, comprising acts of:
providing a mixed ionically and electrically conducting material having a first side and a second side;
flowing an oxidizable species across the first side of the material; and
flowing a reducible species across the second side of the material in a direction that is substantially countercurrent relative to the flow of the oxidizable species.

109. The method of claim 108, wherein the oxidizable species comprises a carbonaceous fuel.

110. The method of claim 108, wherein the reducible species comprises water.

111. The method of claim 108, wherein the mixed ionically and electrically conducting material comprises a ceramic.

112. The method of claim 108, wherein the mixed ionically and electrically conducting material comprises a ceramic ionic conductor and a ceramic electrical conductor.

113. A reactor, comprising:
a mixed ionically and electrically conducting material having a first side and a second side;
a source of an oxidizable species directed for flow across the first side of the material; and
a source of a reducible species directed for flow across the second side of the material in a direction that is substantially countercurrent relative to the flow of the oxidizable species.

114. The reactor of claim 113, wherein the mixed ionically and electrically conducting material comprises a ceramic.

115. The reactor of claim 113, wherein the mixed ionically and electrically conducting material comprises a ceramic ionic conductor and a ceramic electrical conductor.

116. A reactor, comprising:
a mixed ionically and electrically conducting material, having a porosity of less than about 1 open pore/mm², separating a chamber into a first compartment and a second compartment.

117. The reactor of claim 116, wherein the material comprises a ceramic.

118. The reactor of claim 116, wherein the material comprises a ceramic ionic conductor and a ceramic electrical conductor.

119. The reactor of claim 116, wherein the material comprises a first phase comprising a ceramic ionic conductor and a second phase comprising a ceramic electrical conductor, the first phase being substantially interconnected throughout the material such that the material is ionically conductive, and the second phase being substantially interconnected throughout the material such that the material is electronically conductive.

120. The reactor of claim 116, wherein the material comprises YSZ.

121. The reactor of claim 116, wherein the material comprises a yttrium doped Group 2 titanium oxide.

122. The reactor of claim 116, wherein the material has a porosity of less than about 1 open pore/cm².

123. A reactor, comprising:
a material separating a chamber into a first compartment and a second compartment, the material comprising a first phase comprising a ceramic ionic conductor and a second phase comprising a ceramic electrical conductor, the first phase being substantially interconnected throughout the material such that the material is ionically conductive, and the second phase being substantially interconnected throughout the material such that the material is electronically conductive, wherein the ceramic electrical conductor includes a ceramic having a formula:
A_{1-y}EₓTiO₃,
x being between about 0.1 and about 0.99, y being between x and 2x, E representing one or more Group 2 elements, and A representing one or more atoms, each independently selected from the group consisting of Y, Sc, Ce, La, Nb, Yb, Gd, Sm, and Pr.

124. The reactor of claim 123, wherein y is 1.5x.

125. The reactor of claim 123, wherein E includes one or more of Mg, Ca, Ba, and/or Sr.

126. The reactor of claim 123, wherein A comprises La.

127. The reactor of claim 123, wherein A consists essentially of La.

128. The reactor of claim 123, wherein A comprises Y.

129. The reactor of claim 123, wherein A consists essentially of Y.

130. The reactor of claim 123, wherein x is between about 0.2 and about 0.9.

131. The reactor of claim 123, wherein between about 5 wt % and about 95 wt % of the material is the ceramic electrical conductor.

132. The reactor of claim 123, wherein between about 20 wt % and about 80 wt % of the material is the ceramic electrical conductor.

133. A reactor, comprising:
a mixed ionically and electrically conducting material separating a chamber into a first compartment and a second compartment, the material comprising a first phase comprising a YSZ and a second phase comprising a yttrium doped Group 2 titanium oxide, the first phase being substantially interconnected throughout the material such that the material is ionically conductive, and the second phase being substantially interconnected throughout the material such that the material is electronically conductive.

134. A reactor, comprising:
a material separating a chamber into a first compartment and a second compartment, the material comprising a first phase comprising a ceramic ionic conductor and a second phase comprising a ceramic electrical conductor, the first phase being substantially interconnected throughout the material such that the material is ionically conductive, and the second phase being substantially interconnected throughout the material such that the material is electronically conductive, wherein the material has a resistivity of less than about 200 Ohm cm.

135. The reactor of claim 134, wherein the first phase comprises YSZ.

136. The reactor of claim 134, wherein the second phase comprises a yttrium doped Group 2 titanium oxide.

137. The reactor of claim 134, wherein the resistivity is less than about 100 Ohm cm.
